(19) United States
(12) Patent Application Publication
(10) Pub. No.: US 2022/0019230 A1
(43) Pub. Date: Jan. 20, 2022

(54) INFORMATION PROCESSING APPARATUS, INFORMATION PROCESSING SYSTEM, NON-TRANSITORY COMPUTER READABLE MEDIUM, AND AUTONOMOUS VEHICLE

(71) Applicant: TOYOTA JIDOSHA KABUSHIKI KAISHA, Toyota-shi (JP)

(72) Inventors: Yurika TANAKA, Yokosuka-shi (JP); Shoji SAKAMOTO, Ichikawa-shi (JP); Kenichi YAMADA, Nisshin-shi (JP); Yuko MIZUNO, Nagoya-shi (JP); Hiromitsu FUJII, Kariya-shi (JP); Katsuhiro OHARA, Nagoya-shi (JP)

(73) Assignee: TOYOTA JIDOSHA KABUSHIKI KAISHA, Toyota-shi (JP)

(21) Appl. No.: 17/370,600

(22) Filed: Jul. 8, 2021

(30) Foreign Application Priority Data
Jul. 17, 2020 (JP) 2020-122985

(51) Int. Cl. G05D 1/02; B62B 5/00; G05D 1/00; G01C 21/34; G06Q 30/06

(52) U.S. Cl. CPC G05D 1/0219; B62B 5/0096; G05D 1/0088; G05D 2201/0216; G01C 21/3415; G06Q 30/0633; G05D 1/0274

(57) ABSTRACT

An information processing apparatus for controlling an autonomous vehicle configured to move in a shop includes a controller. The controller is configured to acquire recipe information for a cooking menu selected by a user, identify a display location of at least one ingredient necessary for completing the cooking menu based on the acquired recipe information, generate route information on a route to the identified display location, and provide the generated route information to the autonomous vehicle.

### CROSS-REFERENCE TO RELATED APPLICATION

This application claims priority to Japanese Patent Application No. 2020-122985, filed Jul. 17, 2020, the entire contents of which are incorporated herein by reference.

### TECHNICAL FIELD

The present disclosure relates to an information processing apparatus, an information processing system, a program, and an autonomous vehicle.

### BACKGROUND

A support system for users to purchase food necessary for daily life in shops such as supermarkets and shopping centers is known. For example, patent literature (PTL) 1 discloses a product sales support system that consists of shopping carts and a product information processing apparatus for processing information for each shopping cart. Each shopping cart includes a reading apparatus for reading product information recorded on a radio frequency identifier (RFID), a data communication apparatus, and a display apparatus. In such a product sales support system, the product information processing apparatus retrieves a cooking menu and recipe information for the cooking menu from product identification information and information on the shopper received from the shopping cart.

### CITATION LIST

### Patent Literature

PTL 1: JP 2013-037428 A

### SUMMARY

With this technology, recipe information is provided in real time by the product sales support system for the ingredients selected by a user. However, in the case of users themselves devising and choosing a cooking menu and then going shopping at a shop, sufficient consideration has not been given to support technology for purchasing all of the ingredients necessary for the recipe without omitting any ingredients. In such a case, it may be burdensome for the user to secure all of the ingredients necessary for the recipe in the shop without omitting any ingredients.

It would be helpful to provide technology for reducing the burden on the user when securing ingredients, necessary for a recipe of a cooking menu desired by the user, in a shop without omitting any ingredients.

An information processing apparatus according to an embodiment of the present disclosure is an information processing apparatus for controlling an autonomous vehicle configured to move in a shop, the information processing apparatus including a controller configured to acquire recipe information for a cooking menu selected by a user, identify a display location of at least one ingredient necessary for completing the cooking menu based on the acquired recipe information, generate route information on a route to the identified display location, and provide the generated route information to the autonomous vehicle.

A program according to an embodiment of the present disclosure is configured to cause an information processing apparatus for controlling an autonomous vehicle configured to move in a shop to execute operations including acquiring recipe information for a cooking menu selected by a user, identifying a display location of at least one ingredient necessary for completing the cooking menu based on the acquired recipe information, generating route information on a route to the identified display location, and providing the generated route information to the autonomous vehicle.

An autonomous vehicle according to an embodiment of the present disclosure is an autonomous vehicle configured to move in a shop and includes a controller configured to acquire recipe information for a cooking menu selected by a user, identify a display location of at least one ingredient necessary for completing the cooking menu based on the acquired recipe information, and generate route information on a route to the identified display location.

According to the information processing apparatus, the information processing system, the program, and the autonomous vehicle of an embodiment of the present disclosure, the burden on the user is reduced when the user secures ingredients, necessary for a recipe of a cooking menu desired by the user, in a shop without omitting any ingredients.

### BRIEF DESCRIPTION OF THE DRAWINGS

In the accompanying drawings:

FIG. 1 is a configuration diagram illustrating a configuration of an information processing system that includes an information processing apparatus according to an embodiment of the present disclosure;

FIG. 2 is a functional block diagram illustrating a schematic configuration of each of the information processing apparatus, an autonomous vehicle, and a terminal apparatus illustrated in FIG. 1;

FIG. 3 is a flowchart illustrating an example of an information processing method executed by the information processing apparatus of FIG.

1;

FIG. 4 is a sequence diagram illustrating an example of an information processing method executed by the information processing system of FIG. 1; and FIG. 5 is a diagram illustrating example processing performed by a controller of the information processing apparatus in FIG. 2.

### DETAILED DESCRIPTION

An embodiment of the present disclosure is described below with reference to the drawings.

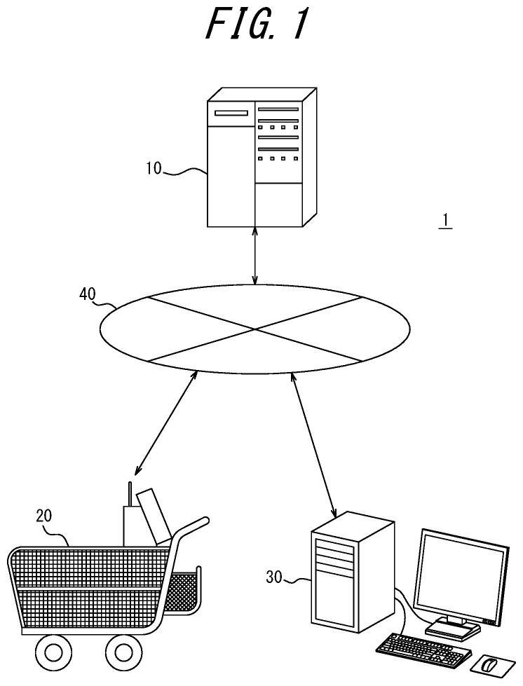

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to an embodiment of the present disclosure is primarily described. The information processing system 1 includes an autonomous vehicle 20 and a terminal apparatus 30 in addition to the information processing apparatus 10.

For simplicity of explanation in FIG. 1, only one each of the information processing apparatus 10, the autonomous vehicle 20, and the terminal apparatus 30 are illustrated, but the information processing system 1 may have two or more each of information processing apparatuses 10, autonomous vehicles 20, and terminal apparatuses 30. Each of the information processing apparatus 10, the autonomous vehicle 20, and the terminal apparatus 30 is communicably connected to a network 40 including, for example, a mobile communication network and the Internet.

The information processing apparatus 10 is a single server apparatus or a plurality of server apparatuses that can communicate with each other. The information processing apparatus 10 is not limited to these and may be any general-purpose electronic device such as a personal computer (PC) or a smartphone, or may be any other dedicated electronic device for the information processing system 1.

The autonomous vehicle 20 includes, for example, any vehicle that moves in a shop by autonomous operation. For example, the autonomous vehicle 20 includes a shopping cart. In the present specification, the “shop” includes, for example, any shop in which a user can purchase food or the like necessary for daily life. For example, the “shop” includes shops such as supermarkets and shopping centers.

The terminal apparatus 30 is a general-purpose electronic device, such as a PC or a smartphone. The terminal apparatus 30 is, for example, an electronic device used by the person in charge of the shop managing the autonomous vehicle 20. The terminal apparatus 30 may be a server apparatus used in a shop, or a plurality of such server apparatuses that can communicate with each other, or the terminal apparatus 30 may be a dedicated electronic device for the information processing system 1. However, these examples are not limiting.

As a summary of one embodiment, the information processing apparatus 10 controls an autonomous vehicle 20 that moves in the shop. The information processing apparatus 10 acquires recipe information for the cooking menu selected by the user. In the present specification, the “recipe information” includes, for example, the ingredients necessary to complete the cooking menu, a cooking method for completing the cooking menu using those ingredients, and the like.

The information processing apparatus 10 identifies the display location, in the shop, of the ingredients necessary to complete the cooking menu based on the acquired recipe information. The information processing apparatus 10 generates route information on a route in the shop to the identified display location and provides the route information to the autonomous vehicle 20. In the present specification, the “route information” includes, for example, the order in which the autonomous vehicle 20 is guided to the display locations of a plurality of ingredients, the route from the current location of the autonomous vehicle 20 to the display locations, the time when the autonomous vehicle 20 passes through a predetermined point on the route, information regarding a standby operation while the user secures an ingredient at the display location of the ingredient, and the like.

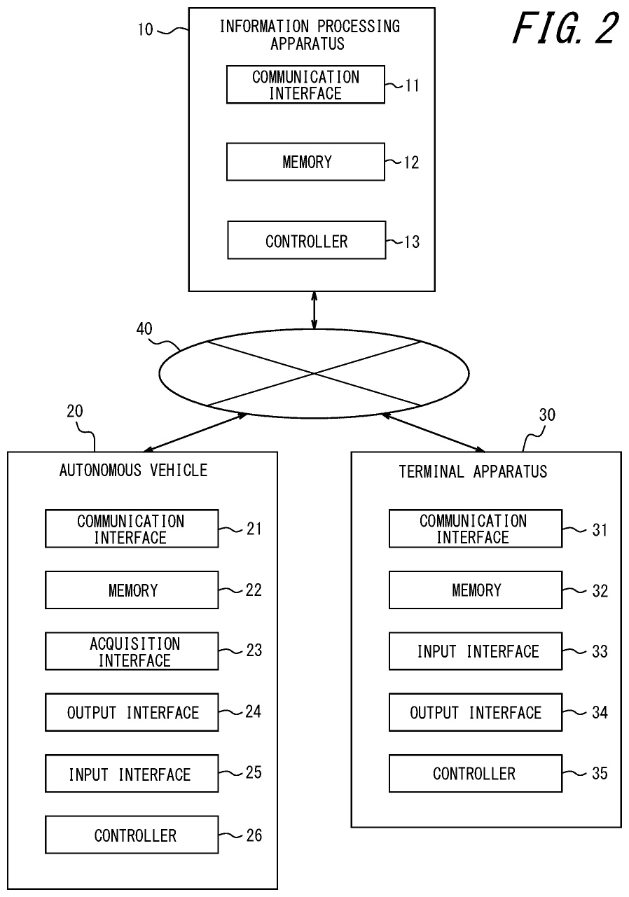

Next, referring to FIG. 2, the configuration of each of the information processing apparatus 10, the autonomous vehicle 20, and the terminal apparatus 30 included in the information processing system 1 is mainly described. FIG. 2 is a functional block diagram illustrating the schematic configuration of each of the information processing apparatus 10, the autonomous vehicle 20, and the terminal apparatus 30 of FIG. 1.

As illustrated in FIG. 2, the autonomous vehicle 20 includes a communication interface 21, a memory 22, an acquisition interface 23, an output interface 24, an input interface 25, and a controller 26.

The communication interface 21 includes a communication module that connects to the network 40. For example, the communication interface 21 may include a communication module compliant with mobile communication standards such as the 4th generation (4G) and the 5th generation (5G) standards. In an embodiment, the autonomous vehicle 20 connects to the network 40 via the communication interface 21. The communication interface 21 transmits and receives various information via the network 40.

The memory 22 is, for example, a semiconductor memory, a magnetic memory, an optical memory, or the like, but is not limited to these. The memory 22 may function as, for example, a main memory, an auxiliary memory, or a cache memory. The memory 22 stores any information used for operations of the autonomous vehicle 20. For example, the memory 22 stores information, acquired by the acquisition interface 23, on the ingredients contained in the autonomous vehicle 20. In the present specification, the “information on ingredients” includes, for example, the type, price, and quantity of ingredients. Additionally, the memory 22 may, for example, store system programs, application programs, various information transmitted or received by the communication interface 21, and the like. The information stored in the memory 22 may be updated with information received from the network 40 via the communication interface 21, for example.

The acquisition interface 23 includes any appropriate sensor module capable of acquiring information on the ingredients contained in the autonomous vehicle 20. For example, the acquisition interface 23 may include an imaging module that can capture images of the ingredients contained in the autonomous vehicle 20. For example, the acquisition interface 23 may include a reading module that can read information embedded in an RFID tag attached to packaging of an ingredient.

In addition, the acquisition interface 23 includes one or more receivers corresponding to any appropriate satellite positioning system. For example, the acquisition interface 23 may include a Global Positioning System (GPS) receiver. The acquisition interface 23 acquires the measured position of the autonomous vehicle 20 in the shop as positional information. The acquisition interface 23 may acquire the positional information for the autonomous vehicle 20 continuously, periodically, or non-periodically.

The output interface 24 includes at least one output interface for outputting information to notify information to the user. The output interface 24 is, for example, a display for outputting the information as images, a speaker for outputting the information as audio, or the like, but is not limited to these. For example, the output interface 24 outputs various information received by the communication interface 21, various information stored in the memory 22, and the like to notify the user.

The input interface 25 includes at least one input interface for detecting user input to acquire input information based on an operation by a user. For example, the input interface 25 may include a physical key, a capacitive key, a touchscreen integrally provided with a display of the output interface 24, a microphone for receiving audio input, and the like.

The controller 26 includes at least one processor. The “processor” is a general-purpose processor or a dedicated processor that is dedicated to specific processing in an embodiment but is not limited to these. The controller 26 is communicably connected with the components of the autonomous vehicle 20 and controls the operations of the entire autonomous vehicle 20.

Next, the configuration of the terminal apparatus 30 included in the information processing system 1 is mainly described. As illustrated in FIG. 2, the terminal apparatus 30 includes a communication interface 31, a memory 32, an input interface 33, an output interface 34, and a controller 35.

The communication interface 31 includes a communication module that connects to the network 40. For example, the communication interface 31 may include a communication module compliant with mobile communication standards such as the 4G and the 5G standards, or Internet standards. In an embodiment, the terminal apparatus 30 connects to the network 40 via the communication interface 31. The communication interface 31 transmits and receives various information via the network 40.

The memory 32 is, for example, a semiconductor memory, a magnetic memory, an optical memory, or the like, but is not limited to these. The memory 32 may function as, for example, a main memory, an auxiliary memory, or a cache memory. The memory 32 stores any information used for operations of terminal apparatus 30. For example, the memory 32 may store system programs, application programs, various information transmitted by the communication interface 31, and the like. The information stored in the memory 32 may be updated with information received from the network 40 via the communication interface 31, for example.

The input interface 33 includes at least one input interface for detecting user input to acquire input information based on an operation by a user. For example, the input interface 33 may include a physical key, a capacitive key, a touchscreen integrally provided with a display of the output interface 34, a microphone for receiving audio input, and the like.

The output interface 34 includes at least one output interface for outputting information to notify the user of the information. The output interface 34 is, for example, a display for outputting the information as images, a speaker for outputting the information as audio, or the like, but is not limited to these.

The controller 35 includes at least one processor. The “processor” is a general-purpose processor or a dedicated processor that is dedicated to specific processing in an embodiment but is not limited to these. The controller 35 is communicably connected to the components of the terminal apparatus 30 and controls the operations of the entire terminal apparatus 30.

Next, the configuration of the information processing apparatus 10 included in the information processing system 1 is mainly described. As illustrated in FIG. 2, the information processing apparatus 10 includes a communication interface 11, a memory 12, and a controller 13.

The communication interface 11 includes a communication module that connects to the network 40. For example, the communication interface 11 may include a communication module compliant with mobile communication standards such as the 4G and the 5G standards, or Internet standards. In an embodiment, the information processing apparatus 10 connects to the network 40 via the communication interface 11. The communication interface 11 transmits and receives various information via the network 40.

The memory 12 is, for example, a semiconductor memory, a magnetic memory, an optical memory, or the like, but is not limited to these. The memory 12 may function as, for example, a main memory, an auxiliary memory, or a cache memory. The memory 12 stores any information used for operations of the information processing apparatus 10. For example, the memory 12 may store a system program, an application program, and various information transmitted or received by the communication interface 11. The information stored in the memory 12 may be updated with information received from the network 40 via the communication interface 11, for example.

The controller 13 includes at least one processor. The “processor” is a general-purpose processor or a dedicated processor that is dedicated to specific processing in an embodiment but is not limited to these. The controller 13 is communicably connected to the components of the information processing apparatus 10 and controls the operations of the entire information processing apparatus 10.

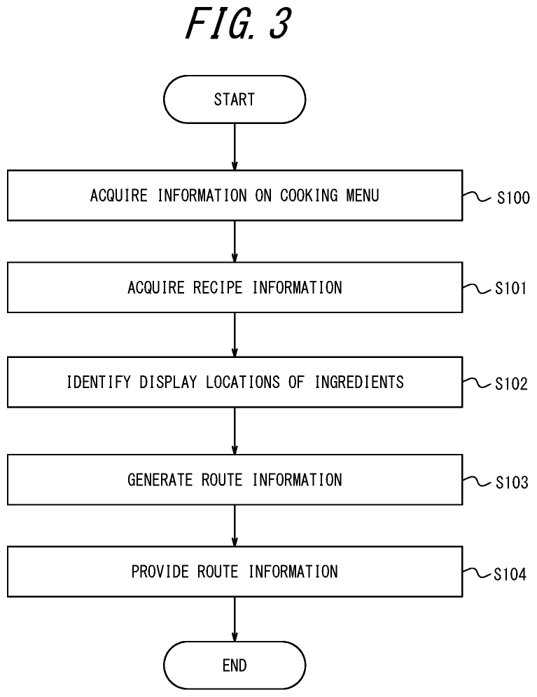

FIG. 3 is a flowchart illustrating an example of an information processing method executed by the information processing apparatus 10 of FIG. 1. The flowchart in FIG. 3 illustrates the flow of basic processing of the information processing method executed by the information processing apparatus 10. The flowchart in FIG. 3 illustrates an example of processing when the information processing apparatus 10 acquires information on a cooking menu, desired by the user, that the user inputs using the input interface 25 of the autonomous vehicle 20 immediately after entering a shop, for example.

In step S100, the controller 13 of the information processing apparatus 10 acquires information on the cooking menu selected by the user from the autonomous vehicle 20. For example, the controller 13 receives information on the cooking menu selected by the user from the autonomous vehicle 20 via the network 40 and the communication interface 11.

In step S101, the controller 13 acquires recipe information for the cooking menu selected by the user based on the information on the cooking menu acquired in step S100. For example, the controller 13 acquires such recipe information by reading the recipe information from the memory 12.

This example is not limiting, however, and the controller 13 may acquire recipe information from another external device, connected to the network 40, each time the information on the cooking menu is acquired in step S100.

In step S102, the controller 13 identifies the display locations of the ingredients necessary to complete the cooking menu based on the recipe information acquired in step S101.

In step S103, the controller 13 generates route information on a route to the display locations of the ingredients identified in step S102.

In step S104, the controller 13 provides the route information generated in step S103 to the autonomous vehicle 20. For example, the controller 13 transmits the route information generated in step S103 to the autonomous vehicle 20 via the communication interface 11 and the network 40.

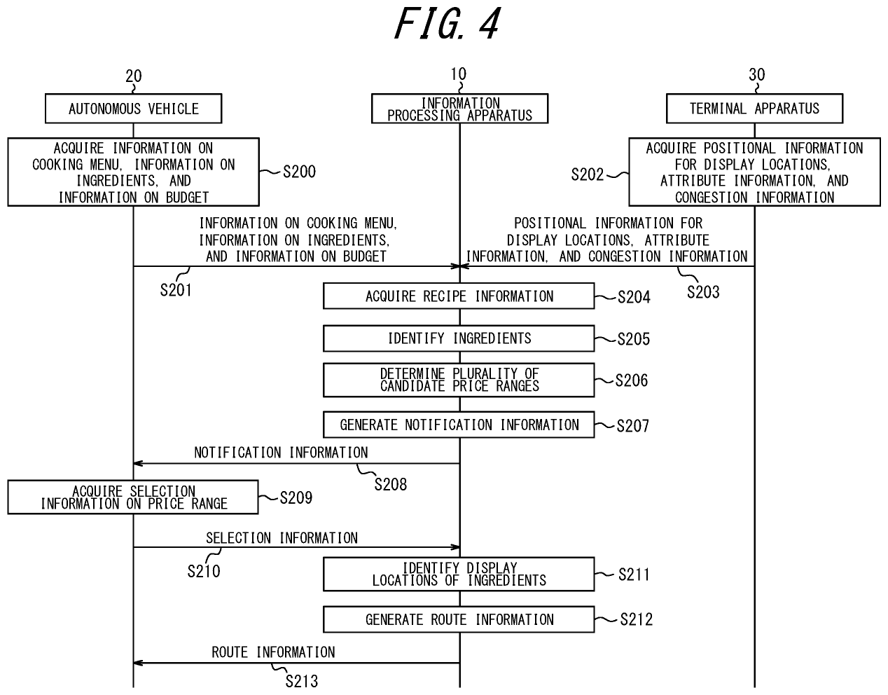

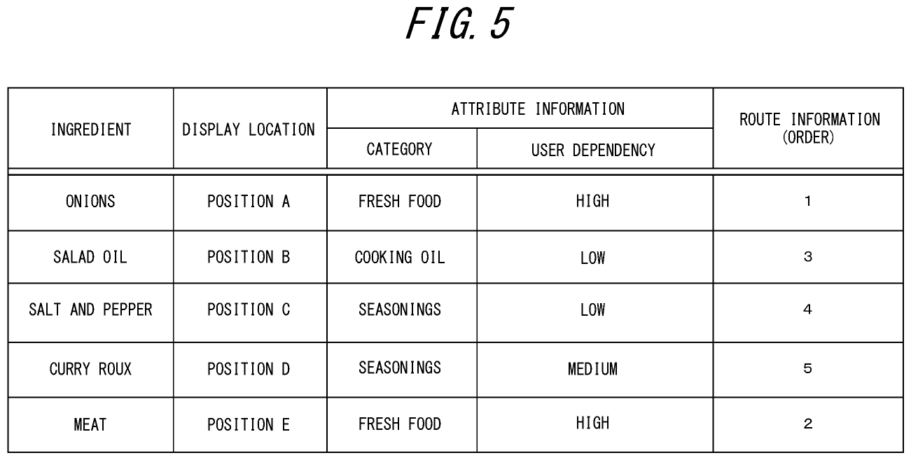

FIG. 4 is a sequence diagram illustrating an example of an information processing method executed by the information processing system 1 of FIG. 1. An example of an information processing method executed by the information processing system 1 of FIG. 1 is described with reference to FIG. 4. With the processing illustrated in FIG. 3 as basic processing, the information processing system 1 may further execute the processing illustrated in FIG. 4. In the sequence diagram in FIG. 4, it is assumed that, for example, a portion of the ingredients necessary for completing the cooking menu is already contained in the autonomous vehicle 20. In this situation, for example, while shopping, the user inputs information on the user's desired cooking menu using the input interface 25 of the autonomous vehicle 20.

In step S200, the controller 26 of the autonomous vehicle 20 acquires the information on the cooking menu, and information on the user's budget for purchasing the ingredients, inputted by the user using the input interface 25. The controller 26 uses the acquisition interface 23 to acquire information on the ingredients contained in the autonomous vehicle 20.

In step S201, the controller 26 of the autonomous vehicle 20 transmits the information on the cooking menu, the information on the ingredients, and the information on the budget acquired in step S200 to the information processing apparatus 10 via communication interface 21 and the network 40.

In step S202, the controller 35 of the terminal apparatus 30 acquires positional information for the display locations of products sold in the shop from the memory 32. The controller 35 acquires attribute information for each of these products from the memory 32. The controller 35 acquires congestion information on the inside of the shop. Such congestion information may, for example, be acquired based on image information from a monitoring camera in the shop or may be acquired based on the number of autonomous vehicles 20 moving in the shop.

In the present specification, the “attribute information” includes, for example, a category as an ingredient, user dependency, and the like. In the present specification, the term “user dependency” refers, for example, to an index indicating the necessity that users themselves identify which individual item to secure, among ingredients of the same type, in light of the quality, expiration date, and the like of each individual item. For example, the user dependency may be represented based on any appropriate index. The user dependency may, for example, be represented by one of three levels: “high”, “medium”, and “low”. At this time, a higher user dependency indicates a higher necessity for users themselves to identify which individual item to secure. Conversely, a lower user dependency indicates a lower necessity for users themselves to identify which individual item to secure. These examples are not limiting, and the user dependency may be represented by a number within any appropriate numerical range. For example, the user dependency may be represented by a number from 0 to 100.

In step S203, the controller 35 of the terminal apparatus 30 transmits the positional information for the display locations, the attribute information, and the congestion information acquired in step S202 to the information processing apparatus 10 via the communication interface 31 and the network 40.

In step S204, the controller 13 of the information processing apparatus 10 acquires the recipe information for the cooking menu selected by the user based on the information on the cooking menu acquired in step 5201.

In step S205, the controller 13 of the information processing apparatus 10 identifies ingredients that are not contained in the autonomous vehicle 20 among a plurality of ingredients necessary for completing the cooking menu. For example, the controller 13 compares the information on the ingredients acquired in step S201 with the recipe information acquired in step S204 to identify missing ingredients that have not been secured in the autonomous vehicle 20.

In step S206, the controller 13 of the information processing apparatus 10 determines, with respect to the ingredients identified in step S205, a plurality of candidate price ranges of ingredients such that the ingredients can be purchased within the user's budget based on the information on the budget acquired in step S201.

In step S207, the controller 13 of the information processing apparatus 10 generates notification information to notify the user of the candidate price ranges determined in step S206. In the present specification, the “notification information” includes, for example, information for outputting candidate price ranges in an output format corresponding to the output interface forming the output interface 24 of the autonomous vehicle 20.

In step S208, the controller 13 of the information processing apparatus 10 provides the notification information generated in step S207 to the autonomous vehicle 20. For example, the controller 13 transmits the notification information generated in step S207 to the autonomous vehicle 20 via the communication interface 11 and the network 40.

In step S209, the controller 26 of the autonomous vehicle 20 notifies the user of the candidate price ranges, by the output interface 24, based on the notification information acquired in step S208. Subsequently, as selection information on the price range, the controller 26 acquires the ingredient price range selected by the user, using the input interface 25, from among the candidate price ranges notified by the output interface 24.

In step S210, the controller 26 of the autonomous vehicle 20 transmits the selection information on the price range acquired in step S209 to the information processing apparatus 10 via the communication interface 21 and the network 40.

In step S211, the controller 13 of the information processing apparatus 10 identifies the display locations of the ingredients necessary for completing the cooking menu. For example, based on the selection information for the price range acquired in step S210, the controller 13 identifies the display locations of the ingredients included in the price range selected by the user. More specifically, the controller 13 identifies the display locations of the ingredients that are identified in step S205 and that have a price range such that the ingredients can be purchased within the user's budget for purchasing ingredients. At this time, the controller 13 identifies the display locations of the ingredients based on the positional information for the display locations acquired in step S203.

In step S212, the controller 13 of the information processing apparatus 10 generates route information on a route to the display locations identified in step S211. For example, the controller 13 generates route information for the ingredients identified in step S205.

For example, the controller 13 may determine the order included in the route information based on the positional information for the display locations. The controller 13 may, for example, determine the order so as to guide the autonomous vehicle 20 to the display locations identified in step S211 in order of proximity from the current position of the autonomous vehicle 20. For example, the controller 13 may determine the order so as to guide the autonomous vehicle 20 to the display locations identified in step S211 in order of proximity from the entrance to the shop.

In addition to the positional information for the display locations, the controller 13 may, for example, determine the order based on the attribute information acquired for each ingredient among the plurality of ingredients in step S203. For example, the controller 13 may also determine the order based on the attribute information for each of the ingredients identified in step S205.

For example, instead of or in addition to determining the order included in the route information based on the positional information for the display locations, the controller 13 may optimize the route information based on the congestion information on the inside of the shop acquired in step S203. For example, instead of or in addition to determining the order included in the route information based on the positional information for the display locations and the attribute information, the controller 13 may optimize the route information based on the congestion information on the inside of the shop acquired in step S203.

For example, so that a plurality of autonomous vehicles 20 moving in the shop stays a predetermined distance or greater apart from one another, the controller 13 may optimize the route information for each autonomous vehicle 20 based on the congestion information on the inside of the shop. For example, the controller 13 may optimize the route information to preferentially guide the autonomous vehicle 20 to the least busy register based on the congestion information on the registers in the shop.

In step S213, the controller 13 of the information processing apparatus 10 provides the autonomous vehicle 20 with the route information generated in step S212. For example, the controller 13 transmits the route information generated in step S212 to the autonomous vehicle 20 via the communication interface 11 and the network 40.

At this time, the controller 26 of the autonomous vehicle 20 executes autonomous operation control of the autonomous vehicle 20 to move in the shop based on the route information acquired in step S213. The controller 26 may output the route information acquired in step S213 to the user via the output interface 24 as necessary.

FIG. 5 is a diagram illustrating an example of processing executed by the controller 13 of the information processing apparatus 10 in FIG. 2. With reference to FIG. 5, a specific example is described in which the order included in the route information is determined based on the positional information for the display locations and the attribute information, for example, in step S212 of FIG. 4.

In the specific example illustrated in FIG. 5, the user uses the input interface 25 of the autonomous vehicle 20 while shopping to input “curry rice”, for example, as the information on the cooking menu desired by the user. At this time, the controller 13 of the information processing apparatus 10 identifies “onions”, “salad oil”, “salt and pepper”, “curry roux”, and “meat” as missing ingredients that are not contained in the autonomous vehicle 20 in step S205 of FIG. 4.

The controller 13 identifies the display locations of the missing ingredients based on the positional information, acquired in step S203 of FIG. 4, for the display locations of the products sold at the shop. For example, the controller 13 identifies that the display location of “onions” is “position A” in the shop. For example, the controller 13 identifies that the display location of “salad oil” is “position B” in the shop. For example, the controller 13 identifies that the display location of “salt and pepper” is “position C” in the shop. For example, the controller 13 identifies that the display location of “curry roux” is “position D” in the shop. For example, the controller 13 identifies that the display location of “meat” is “position E” in the shop.

At this time, it is assumed that the closest positions from the current location of the autonomous vehicle 20 are positions A, B, C, D, and E in this order. When the controller 13 determines the order included in the route information based only on the positional information for the display locations, the controller 13 determines the order so as to guide the autonomous vehicle 20 to each display location in order of proximity from the current location of the autonomous vehicle 20. In other words, the controller 13 determines the order for positions A, B, C, D, and E to be from the first to the fifth, respectively. The user is guided by the autonomous vehicle 20 in the order of positions A, B, C, D, and E.

In addition to the positional information for the display locations, the controller 13 may also determine the order based on the attribute information acquired for each of the missing ingredients in step S203 of FIG. 4.

The controller 13 acquires information including category “fresh food” and user dependency “high” as attribute information for “onions”. The controller 13 acquires information including category “cooking oil” and user dependency “low” as attribute information for “salad oil”. The controller 13 acquires information including category “seasonings” and user dependency “low” as attribute information for “salt and pepper”. The controller 13 acquires information including category “seasonings” and user dependency “medium” as attribute information for “curry roux”. The controller 13 acquires information including category “fresh food” and user dependency “high” as attribute information for “meat”.

At this time, the controller 13 may preferentially guide the autonomous vehicle 20 to the display locations of ingredients with a high user dependency. For example, the controller 13 determines the order to be such that the display location of “onions”, which have the closest display location to the current location of the autonomous vehicle 20 and which have a high user dependency, is the first. Subsequently, if the order were determined based only on the positional information for the display locations, the second ingredient would be “salad oil”; however, the controller 13 determines the order to be such that the display location of “meat”, which has a high user dependency, is preferentially the second. For the remaining missing ingredients, the controller 13 subsequently determines the order to be such that the display location of “salad oil” is the third, the display location of “salt and pepper” is the fourth, and the display location of “curry roux” is the fifth based on the location information for the display locations.

The controller 13 generates route information assuming that the user and the autonomous vehicle 20 continually move together. This example is not limiting, however, and the controller 13 may generate the route information assuming that the user and the autonomous vehicle 20 temporarily move separately.

For example, in the specific example illustrated in FIG. 5, the controller 13 may generate route information such that the user and the autonomous vehicle 20 temporarily move separately at the display location of “meat” to which the autonomous vehicle 20 and the user are preferentially guided as the second in the order. For example, the controller 13 may generate route information such that the autonomous vehicle 20 is independently guided to the display locations of “salad oil” and “salt and pepper” while the user is spending time discerning which individual item to secure for the “meat”, which has a “high” user dependency.

After the autonomous vehicle 20 secures the ingredients “salad oil” and “salt and pepper” automatically using display shelves of these ingredients and any appropriate mechanism of the autonomous vehicle 20, the controller 13 may generate route information to guide the autonomous vehicle 20 back to the display location of the “meat”, where the user who is discerning the individual item to secure is located. The controller 13 may generate route information so as to guide both the user and the autonomous vehicle 20, who reunited at the display location of the “meat”, to the fifth display location, i.e., the “curry roux”.

Since the user dependency of “curry roux” is “medium”, the user requires some time to discern which individual item to secure. There are no other missing ingredients, however, to complete the cooking menu “curry rice” selected by the user. Therefore, the controller 13 may generate the route information so that the autonomous vehicle 20 stands by at the display location of the “curry roux” until the user finishes securing the ingredients.

The above example is not limiting, and the controller 13 may optimize the route information based on the congestion information, acquired in step S203 of FIG. 4, on the inside of the shop. For example, when the controller 13 acquires information indicating that a predetermined register is not busy as congestion information on the registers in the shop, the controller 13 may optimize the route information so that between the user and the autonomous vehicle 20 who were guided together to the fifth display location, i.e., the “curry roux”, the autonomous vehicle 20 alone is guided first to the predetermined register.

For example, when the controller 13 acquires information that a predetermined register is not busy as the congestion information on the registers in the shop, the controller 13 may determine the order to be such that the display location of the “curry roux” is preferentially the third. The controller 13 may determine the order to be such that the display locations of the “salad oil” and “salt and pepper”, which have a low user dependency, are the fourth and the fifth, respectively. At this time, the controller 13 may optimize the route information so that the user and the autonomous vehicle 20 are guided to a predetermined register after the user guided to the third display location, i.e., “curry-roux”, has secured the ingredient in the autonomous vehicle 20.

The controller 13 may generate route information such that the user and the autonomous vehicle 20 temporarily move separately when guided to a predetermined register. For example, the controller 13 may optimize the route information so that while the user is waiting in line to check out at the register, the autonomous vehicle 20 is guided to the display locations “salad oil” and “salt and pepper”, which have a low necessity that the user discern the individual items to secure. The controller 13 may optimize the route information so that the autonomous vehicle 20 automatically secures these ingredients and is again guided to the predetermined register.

According to the above embodiment, the burden on the user to secure the ingredients, necessary for the recipe of the cooking menu desired by the user, in the shop without omitting any ingredients is reduced. For example, the information processing apparatus 10 generates route information on a route to the display locations of the ingredients necessary for completing the cooking menu desired by the user and provides the route information to the autonomous vehicle 20. This allows the autonomous vehicle 20 to move automatically to the display locations of the ingredients necessary for the cooking menu. Accordingly, it suffices for the user to input information on the cooking menu using the input interface 25 of the autonomous vehicle 20 immediately after entering the shop or while shopping. The user is then spared the trouble of searching for the display locations of the ingredients and can instead simply move together with the autonomous vehicle 20. As a result, the convenience for the user improves, and the shop attracts more customers.

The information processing apparatus 10 identifies ingredients that are not contained in the autonomous vehicle 20 among a plurality of ingredients and generates route information for the identified ingredients to avoid redundant movement to the display locations of ingredients already contained in the autonomous vehicle 20 among the necessary ingredients. The user can thereby move reliably to the display location of the remaining missing ingredients while avoiding redundant movement. Consequently, the user can move efficiently in the shop.

When the information processing apparatus 10 determines the order included in the route information based on the positional information for the display locations of the ingredients, the user can, for example, take the shortest route past the display location of each ingredient necessary for completing the cooking menu. Additionally, the user can secure the ingredients displayed in one department, without omitting any ingredients, when moving to that department. Wasteful movement by the user in the shop, such as moving to the produce department, then to the meat department, and then back to the produce department, can thereby be avoided. As described above, the burden on the user when securing ingredients, necessary for the recipe of the cooking menu desired by the user, in the shop without omitting any ingredients is reduced.

When the information processing apparatus 10 determines the order included in the route information based on the acquired attribute information, the user can preferentially move to the display locations of ingredients for which the user needs to spend time discerning which individual item to secure. While the user is thus in the process of discerning, the autonomous vehicle 20 can also automatically secure another ingredient and then reunite with the user. The user can therefore be assisted by the autonomous vehicle 20 with such shopping and can secure ingredients more efficiently than when shopping alone. As described above, the burden on the user when securing ingredients, necessary for the recipe of the cooking menu desired by the user, in the shop without omitting any ingredients is reduced.

When the information processing apparatus 10 optimizes the route information based on the acquired congestion information on the inside of the shop, the user and the autonomous vehicle 20 can secure the necessary ingredients while optimizing the movement in the shop in accordance with the congestion conditions in the shop. For example, either one of the user and the autonomous vehicle 20 can move to the register when the register is not busy according to the congestion status of the register, so that one of the user and the autonomous vehicle 20 can secure a place in line at the register while the other secures necessary ingredients. The user can thereby be assisted by the autonomous vehicle 20 with such shopping and can secure ingredients more efficiently than when shopping alone. As described above, the burden on the user when securing ingredients, necessary for the recipe of the cooking menu desired by the user, in the shop without omitting any ingredients is reduced.

By the information processing apparatus 10 identifying the display locations of ingredients that have a price range such that the ingredients can be purchased within the user's budget for purchasing ingredients, the user can easily purchase each ingredient necessary for completing the cooking menu within the user's budget. When the user envisions a predetermined budget, the user does not need to check the price of the ingredients already secured and calculate the remaining budget each time the user secures one of the remaining ingredients. The burden on the user when securing ingredients, necessary for the recipe of the cooking menu desired by the user, in the shop within the predetermined budget without omitting any ingredients is therefore reduced.

By the information processing apparatus 10 generating notification information and providing the notification information to the autonomous vehicle 20, the degree of freedom for selecting the price range of ingredients that can be purchased within the user's budget increases as compared to the above case of the information processing apparatus 10 automatically identifying the display locations of ingredients in a price range such that the ingredients can be purchased within the user's budget. For example, the user can select the highest price range for all of the ingredients necessary for completing the cooking menu without having the total price exceed the budget. Conversely, the user can select the lowest price range for all of the ingredients necessary for completing the cooking menu. In this way, the user can secure ingredients in accordance with the user's inclinations, such as using up the budget or saving more money within the budget.

While the present disclosure has been described based on the drawings and examples, it should be noted that various changes and modifications can be made by those skilled in the art based on the present disclosure. Accordingly, such changes and modifications are included within the scope of the present disclosure. For example, the functions or the like included in each configuration, each step, or the like, can be rearranged without logical inconsistency, and a plurality of configurations, steps, or the like can be combined into one or divided.

For example, at least a portion of the processing operations executed in the information processing apparatus 10 in the above embodiment may be executed in the autonomous vehicle 20 or the terminal apparatus 30. For example, instead of the information processing apparatus 10, the autonomous vehicle 20 itself may execute the above-described processing operations related to the information processing apparatus 10. At least a portion of the processing operations executed in the autonomous vehicle 20 or the terminal apparatus 30 may be executed in the information processing apparatus 10.

For example, a configuration in which a general-purpose electronic device such as a smartphone, a computer, or the like is caused to function as the information processing apparatus 10 according to the above embodiment can be adopted. Specifically, a program containing processes for realizing the functions of the information processing apparatus 10 or the like according to the embodiment may be stored in a memory of the electronic device, and the program may be read and executed by a processor of the electronic device. Accordingly, the disclosure according to an embodiment can also be implemented as a program executable by a processor.

Alternatively, the disclosure according to an embodiment can also be implemented as a non-transitory computer readable medium storing a program executable by a single processor or a plurality of processors to cause the information processing apparatus 10 or the like according to the embodiment to execute the functions. It is to be understood that these are also included within the scope of the present disclosure.

For example, the information processing apparatus 10 described in the above embodiment may be mounted on the autonomous vehicle 20. At this time, the information processing apparatus 10 may communicate information directly with the autonomous vehicle 20, without passing through the network 40.

As illustrated in FIG. 4 in the above embodiment, the information processing apparatus 10 in the information processing system 1, for example, has been described as executing various processes, but this example is not limiting. The information processing apparatus 10 need not execute part of the processing illustrated in FIG. 4 as long as the information processing apparatus 10 executes the processing illustrated in FIG. 3 as basic processing.

For example, the controller 13 of the information processing apparatus 10 has been described as identifying ingredients that are not contained in the autonomous vehicle 20 among a plurality of ingredients and generating route information for the identified ingredients, but this example is not limiting. The controller 13 need not perform these processes. For example, the controller 13 need not perform these processes if no ingredients are contained in the autonomous vehicle 20 immediately after the user enters the shop.

For example, the controller 13 of the information processing apparatus 10 has been described as determining the order included in the route information based on the positional information for the display locations, but this example is not limiting. The controller 13 need not perform such a process.

For example, the controller 13 of the information processing apparatus 10 has been described as determining the order included in the route information based on the attribute information in addition to the positional information for the display locations, but this example is not limiting. The controller 13 need not perform such a process.

For example, the controller 13 of the information processing apparatus 10 has been described as optimizing the route information based on the congestion information on the inside of the shop, but this example is not limiting. The controller 13 need not perform such a process.

For example, the controller 13 of the information processing apparatus 10 has been described as acquiring information on the user's budget for purchasing ingredients and identifying the display locations of ingredients that have a price range such that the ingredients can be purchased within the budget, but this example is not limiting. The controller 13 need not perform these processes.

For example, the controller 13 of the information processing apparatus 10 has been described as determining a plurality of candidate price ranges of ingredients such that the ingredients can be purchased within the budget, generating notification information to notify the user of the determined candidate price ranges, and providing the notification information to the autonomous vehicle 20, but this example is not limiting. The controller 13 need not perform these processes.

In the above embodiment, the information processing system 1 has been described as including the information processing apparatus 10, the autonomous vehicle 20, and the terminal apparatus 30, but this example is not limiting. The information processing system 1 may instead include only the information processing apparatus 10 and the autonomous vehicle 20, without including the terminal apparatus 30 of the shop.

In the above embodiment, the controller 13 of the information processing apparatus 10 has been described as determining the order included in the route information based on the user dependency among the attribute information, but this example is not limiting. The controller 13 may determine the order included in the route information based on the category among the attribute information. For example, the controller 13 may determine the order included in the route information so as to leave ingredients included in categories such as fresh food and frozen foods until later, after first guiding the autonomous vehicle 20 to the display locations of ingredients included in categories such as seasonings.

1. An information processing apparatus for controlling an autonomous vehicle configured to move in a shop, the information processing apparatus comprising a controller configured to:
acquire recipe information for a cooking menu selected by a user;
identify a display location of at least one ingredient necessary for completing the cooking menu based on the acquired recipe information;
generate route information on a route to the identified display location; and
provide the generated route information to the autonomous vehicle.

2. The information processing apparatus of claim 1, wherein
the at least one ingredient comprises a plurality of ingredients, and
the controller is configured to identify an ingredient that is not contained in the autonomous vehicle among the plurality of ingredients and generate the route information for the identified ingredient.

3. The information processing apparatus of claim 1, wherein
the at least one ingredient comprises a plurality of ingredients,
the route information includes an order in which the autonomous vehicle is guided to display locations of the plurality of ingredients, and
the controller is configured to determine the order based on positional information for the display locations.

4. The information processing apparatus of claim 3, wherein the controller is configured to acquire attribute information for each ingredient among the plurality of ingredients and determine the order based on the acquired attribute information.

5. The information processing apparatus of claim 1, wherein the controller is configured to acquire congestion information on an inside of the shop and optimize the route information based on the acquired congestion information.

6. The information processing apparatus of claim 1, wherein the controller is configured to acquire information on a budget of the user for purchasing the at least one ingredient and identify a display location of the at least one ingredient having a price range such that the at least one ingredient can be purchased within the budget.

7. The information processing apparatus of claim 6, wherein the controller is configured to determine a plurality of candidate price ranges of the at least one ingredient such that the at least one ingredient can be purchased within the budget, generate notification information to notify the user of the determined plurality of candidate price ranges, and provide the generated notification information to the autonomous vehicle.

8. An information processing system comprising:
the information processing apparatus of claim 1; and
the autonomous vehicle configured to acquire the route information generated by the information processing apparatus.

9. A non-transitory computer readable medium storing a program executable by one or more processors to cause an information processing apparatus for controlling an autonomous vehicle configured to move in a shop to execute functions comprising:
acquiring recipe information for a cooking menu selected by a user;
identifying a display location of at least one ingredient necessary for completing the cooking menu based on the acquired recipe information;
generating route information on a route to the identified display location; and
providing the generated route information to the autonomous vehicle.

10. The non-transitory computer readable medium of claim 9, wherein
the at least one ingredient comprises a plurality of ingredients, and
the functions further comprise identifying an ingredient that is not contained in the autonomous vehicle among the plurality of ingredients and generating the route information for the identified ingredient.

11. The non-transitory computer readable medium of claim 9, wherein
the at least one ingredient comprises a plurality of ingredients,
the route information includes an order in which the autonomous vehicle is guided to display locations of the plurality of ingredients, and
the functions further comprise determining the order based on positional information for the display locations.

12. The non-transitory computer readable medium of claim 11, wherein the functions further comprise acquiring attribute information for each ingredient among the plurality of ingredients and determining the order based on the acquired attribute information.

13. The non-transitory computer readable medium of claim 9, wherein the functions further comprise acquiring congestion information on an inside of the shop and optimizing the route information based on the acquired congestion information.

14. The non-transitory computer readable medium of claim 9, wherein the functions further comprise acquiring information on a budget of the user for purchasing the at least one ingredient and identifying a display location of the at least one ingredient having a price range such that the at least one ingredient can be purchased within the budget.

15. An autonomous vehicle configured to move in a shop, the autonomous vehicle comprising a controller configured to:
acquire recipe information for a cooking menu selected by a user;
identify a display location of at least one ingredient necessary for completing the cooking menu based on the acquired recipe information; and
generate route information on a route to the identified display location.

16. The autonomous vehicle of claim 15, wherein
the at least one ingredient comprises a plurality of ingredients, and
the controller is configured to identify an ingredient that is not contained in the autonomous vehicle among the plurality of ingredients and generate the route information for the identified ingredient.

17. The autonomous vehicle of claim 15, wherein
the at least one ingredient comprises a plurality of ingredients,
the route information includes an order in which the autonomous vehicle is guided to display locations of the plurality of ingredients, and
the controller is configured to determine the order based on positional information for the display locations.

18. The autonomous vehicle of claim 17, wherein the controller is configured to acquire attribute information for each ingredient among the plurality of ingredients and determine the order based on the acquired attribute information.

19. The autonomous vehicle of claim 15, wherein the controller is configured to acquire congestion information on an inside of the shop and optimize the route information based on the acquired congestion information.

20. The autonomous vehicle of claim 15, wherein the controller is configured to acquire information on a budget of the user for purchasing the at least one ingredient and identify a display location of the at least one ingredient having a price range such that the at least one ingredient can be purchased within the budget.
